(19) United States
(12) Patent Application Publication
(10) Pub. No.: US 2003/0022719 A1
(43) Pub. Date: Jan. 30, 2003

(54) Regulation of gaming systems

(76) Inventors: Jan Forbes Donald, Bcaumaris (AU); Elik Szewach, Caulfield South (AU); Lisa Hotten, Caulfield South (AU)

Correspondence Address: Rider Bennett, Egan & Arundel, Suite 2000, 333 South Seventh Street, Minneapolis, MN, 55402, US

(21) Appl. No.: 10/204,594

(22) PCT Filed: Feb. 22, 2001
(86) PCT No.: PCT/AU01/00182

(30) Foreign Application Priority Data
Feb. 22, 2000 (AU) PQ 5736
Mar. 9, 2000 (AU) PQ 6149
Mar. 27, 2000 PCT/AU00/00251

(51) Int. Cl. A63F 13/00

(52) U.S. Cl. 463/42

(57) ABSTRACT

A system for regulating gambling and a smart card for use in the system which includes (a) identifying a person; (b) issuing a person with a smart card having clock means or clock reader means with the capability of determining a time period and having a purse associated with the clock or clock reader being able to limit an electronic value input and/or output from the purse on the smart card for a predefined period; (c) setting a maximum input and/or output limit for a predefined period; (d) providing one or more gaming venues having card readers able to interact with the smart cards; and (e) providing linkage to financial sources for electronically transferring verifiable funds to the smart card which are able to be selectively transferred to a gaming venue when the user wishes to undertake a gambling activity; whereby the person can use the smart card to undertake gambling at regulated gambling establishments and have the total amount of accessible funds limited throughout all the regulated gambling establishments for a set period.

### TECHNICAL FIELD

This invention relates to methods and means of regulating gaming systems, including considerations of where such games take place, and how monetary and credit/debit transactions take place before the game commences, during the course of the game and at the completion of the game. The games where this may be used include via Online, pay TV, broadband, Internet, poker machines, lotto, racing venue betting machines (including over the counter and/or stand alone player and Internet operated wagering machines etc). Since aspects of the invention relating to the regulatory systems and protection of financial transactions, conducted over a telecommunications and/or computer network, are applicable elsewhere other than in gaming, this invention also relates to methods for effecting computer and network systems security and to such computer systems.

This invention relates to methods and means of regulating betting on live events, such as football, cricket, soccer, other sporting events, game shows, etc. These regulatory methods and means may be used in all kinds of betting over all types of medium including Internet, free to air TV, wireless transmission, cable, telecommunication lines, broadband networks, computer networks and interactive TV.

### BACKGROUND TO THE INVENTION

Many casinos. Internet gaming establishments, poker, lotto as well as horse racing betting and other gaming establishments seek to attract gamblers of all types and backgrounds to partake in games in the above fields for purposes of wagering and or gambling. There is a significant need for regulation by national governments of the existing and emerging gaming industries especially with the introduction of and the popularity of poker machines. Internet gaming and other new forms of electronic distribution of gaming. Increasing concern in relation to credit card gambling, problem and underage gamblers has been expressed in the international and national media by governments, religious organisations and the public at large. These groups have expressed the urgent need for the gaming industry, as a whole, to be regulated to limit gambling on credit which is seen as a major cause in generating problems including family debt and poverty, family breakdown and crime.

The expansion of gaming via new forms of electronic service delivery and payment where underage persons can gamble remotely without adequate safeguards increases the requirement to regulate better both existing and new forms of gaming. There is a growing requirement by many governments to regulate existing and new gaming products and to ensure that the various methods of financial transactions directly associated with gaming and the delivery systems used for both gaming and associated financial transactions are appropriately regulated. Many individuals when participating in playing games of chance and all other forms of gaming and when undertaking directly related financial transactions desire to remain anonymous but at the same time establish bona fides with the gaming establishment that they are legitimate players with funds available to participate in a particular game.

It is apparent to those who have researched this area that the many types of gambling offered pertaining to gambling have made no provision or attempt to regulate the industry in relation to gambling on credit, problem gamblers and underage gamblers. Further little attempt has been made to regulate the amount wagered per week/month or to protect the problem gambler from their addiction. In addition there has been little attempt to protect sensitive financial data pertaining to the player from use including unauthorised use by gaming establishments.

The US Senate has proposed to ban Internet gambling in part due to its not being regulated and its use of unregulated credit card access. Also in 1999 the Australian Productivity Commission could not find a regulatory product to address the problems associated with unregulated gambling and requested that any organisation which had a solution to contact the Gaming Ministers of the States and Territories of Australia. Growing concern, in relation to credit card gambling, problem gamblers and underage gamblers, has been expressed in the media by national governments. Inter-Church and other religious anti-gaming lobbying groups, courts, social welfare agencies and the public at large. These groups has expressed the desire and need for the gaming industry, as a whole, to be regulated to stop industries from excessive gambling particularly on credit thus creating debt, broken families and crime as is increasingly apparent to courts, religious organisations and welfare agencies.

In addition to addressing the above concerns expressed by these groups, protection of people from addiction to gambling can also be controlled by a better regulated gaming industry. It would be socially desirable, therefore, to have all the above gaming products and methods of transactions and delivery regulated in order to address the concerns mentioned above. It is also a requirement in such games and methods of transactions, to regulate the use of and access to the players personal and financial information thus protecting the player from unauthorised use of the data by gaming establishments and their employees and to minimise any opportunity for fraud and exploitation.

In any such regulatory system, it is essential to ensure a high level of security in order to minimise fraud or misuse by persons having access to this type of personal information. In relation to the financial transaction, details of the player, safeguarding the privacy and financial systems including transactions, access to bank accounts and personal financial data of the player should be minimised in order to reduce the opportunity for misuse affecting the gaming establishment, its players and their banks by individuals who may have access to this information.

### PRIOR ART

U.S. Pat. No. 5,800,268 to Molnick discloses a method of validating the financial transactions of players who participate in a live casino game from remote locations via a communications network. Each remote player receives live television and data signals relating to a casino game at his/her remote station and uses it to convey bet intention information to the casino. Before the player is permitted to join a game or place a bet, the casino establishes a direct and open link to the player's bank or other financial institution that allows the casino to instantaneously:

(i) check that the player has enough credit to cover the bet that is placed;

(ii) pay winnings directly into the players account; and

(iii) recover losses directly from the player's account.

The need to establish and keep open a line to each player's bank creates a risk of fraud or misappropriation of a player's funds by casino employees and potentially the loss of personal and (normally) confidential financial information belonging to the player. Even when there is no misappropriation on the part of the casino or its employees who are privy to the players personal and bank account details, the personal information gained by the casino is of great value in targeting further gaming products and in selling such information to direct marketing agencies.

The Molnick invention relies on direct credit card gambling which a number of national governments, world Inter-Church and other religious bodies and many individuals would wish banned. The Molnick patent does not address regulating the maximum amounts which can be wagered per week/month problem gamblers and underage gamblers who are likely to access the casino or other gaming venues both physically or via cyber space. The ability to deny access to problem or underage gamblers has not been mentioned, as well as the protection of personal and financial information pertaining to the player.

### OBJECT OF INVENTION

It is an object of the present invention to provide a regulatory system that can be applied within either a state or country and/or internationally that will address the following aspects of both personal attendance and remote gambling, direct credit card gambling, problem gamblers, underage gamblers and protection of financial and sensitive details pertaining to the player, while still allowing immediate real time settlement of losses or wins on a game by game basis.

It is also an object of the present invention to provide a method and means of regulating the Gaming Industry. A regulatory system that can be applied within a country or internationally that will address the following: unrestricted credit card gambling, potentially limit the amount wagered per month, bar access to unregulated casinos and Internet gaming sites and other gambling establishments by problem gamblers, underage gamblers and protect and sensitive financial information pertaining to the player.

The present invention addresses the situation where a player may be physically located and gambling in a gaming establishment or taking part in remotely located gambling via a telecommunication or computer type network, e.g. Internet and where the invention has the ability to regulate both situations including:

(i) the amount wagered per week/month;

(ii) the ability for government appointed courts and agencies to disconnect problem gamblers for given amounts of time;

(iii) to bar underage gamblers access;

(iv) to stop or limit direct credit card gambling; and

(v) protect players private banking details from gaming establishments or individuals who may have intentions of unauthorised use or sale the of data.

### OUTLINE OF INVENTION

In accordance with the invention there is provided a smart card for use in controlling money flow, said smart card including a clock or clock reader able to determine the actual time or time relative to previous transactions; a purse for electronically receiving value; an input limiting means providing at least one predetermined limit of electronically received value into said purse in one predetermined period of time with reference to the clock or clock reader; and an output means able to output selectively at least part of the electronically held value in the purse.

The input limiting means can include a plurality of predetermined limits of electronically received value including a first maximum limit, which can be a statutory maximum limit, and a second maximum limit, which can be a voluntary maximum limit able to be selected by the user and encoded into the smart card. Also the input limiting means can provide further limits of certain types of electronically received value, including a limit on credit as they receive the electronic value, a limit on cash and a limit on winnings reinvested in a given period of time.

The smart card can further include an output limiting means enabling selective defining of a limit of an individual output transaction reflecting a maximum single output. The output limiting means further includes allocating predetermined outputs dependant on the selective output from the output means such as for reasons of tax, licence fees or the like. The output limiting means may be interrogated at the time of transactions in order to instigate a removal of the defined outputs to the allocated areas.

Also the smart card can further include an identification means for including details of the user and identification confirming means for receiving input to confirm that the user is the identified user. The confirming means includes the use of a personal identification number (PIN) or biometrics identification system or response to answer or the like.

The output means of the smart card further outputs information as well as electronic value such that the information of transactions may be sent to the Tax Department or operating body or the like. Also the smart card is able to be selectively locked to prevent transactions into or out of the purse until unlocked wherein the locking means can be by means of a personal identification number (PIN), biometric means or other electronic locking means.

The invention also provides a system for regulating gambling including:

(a) identifying a person;

(b) issuing a person with a smart card having clock means or clock reader means with the capability of determining a time period and having a purse associated with the clock or clock reader being able to limit an electronic value input and/or output from the purse on the smart card for a predefined period;

(c) setting a maximum input and/or output limit for a predefined period;

(d) providing one or more gaming venues having card readers able to interact with the smart cards; and

(e) providing linkage to financial sources for electronically transferring verifiable funds to the smart card which are able to be selectively transferred to a gaming venue when the user wishes to undertake a gambling activity;

whereby the person can use the smart card to undertake gambling at regulated gambling establishments and have the total amount of accessible funds limited throughout all the regulated gambling establishments for a set period

The set period can be of the order of a month and the smart card can be used at a plurality of regulated gambling establishments and over a plurality of occasions but with a single input and/or output limit for the month.

The system for regulating gambling can also include providing one or more of the following:

(f) a remote link to the gaming venue wherein the smart card is able to interact with a remote link to the card reader facilities of the gaming venues to allow verifiable funds transfer to a gaming venue when the user wishes to undertake a gambling activity;

(g) a real time visual link with the gambling venue and a real time interaction means for providing real time instructions with regard the gambling activity to enable live remote gambling;

(h) an interaction means for a gaming venue operator separate to or integral with the gaming venues' card readers able to interact with the smart cards wherein the gaming venue operator can operate a live gambling activity and enter details electronically to the interaction means to allow live remote gambling; the interaction means can enable interaction with smart cards of the gaming venue operator in order to identify authorisation of use and allow electronic transactions of funds to and from the smart card to and from the gambling person's smart card.

(i) an identifying means for individually initiating use of each of the smart cards said identifying means using biometric identification or PIN access or password or the like so as to allow only authorised use of each smart card by the person to whom the card was issued;

(j) an identifying means that identifies the user of the card and interacts with the gaming venue by identifying the validity of the use of the smart card by cardholder without providing information of the cardholder such that gambling can occur anonymously with respect to the gaming venue whether transactions occur in person or by remote online access;

(k) review of identified person with a check list and barring continued transactions with the gaming venue if the check list has identified the person as being banned by the courts or other regulatory body or by self inclusion on the check list;

(l) output means for outputting data of individual transactions or transaction flow to one or more authorities or authorised bodies for regulatory purposes such as collection of tax or auditing purposes or other allowable purpose;

(m) output means for outputting data of transactions to one or more authorities or authorised bodies on player's winnings and losses upon authorised access to linked network by means of PIN or other electronic security access;

(n) input limiting means includes a plurality of predetermined limits of electronically received value including a first maximum limit, which can be a statutory maximum limit, and a second maximum limit, which can be a voluntary maximum limit able to be selected by the user and encoded into the smart card; and/or

(o) further limits of certain types of electronically received value as the card receives the electronic value including a limit on credit, a limit on cash and a limit on winnings.

Other variations of the invention will be understood by reference to examples as will be further detailed.

A Protection of Players Personal Data & Means of Transactions

In one preferred or possible mode of play a player can electronically place money in a secure electronic purse before and even during each game so that the purse is electronically accessible to the casino for:

(i) paying losses and wins; and

(ii) checking the player's ability to cover any bet placed during a game.

The use of such a purse avoids any access by the casino to the player's bank and private banking details, in accordance with most player's preferred options. It can allow a player to remain anonymous once the casino has confirmed the validity of the purse and the amount available. The method described above for transactions, which involve the loading of cash onto a player's personal smart card.

A1 Identification

The ABC smart card is used to establish a player's purse for each game is supplied by the regulated gaming establishment and is encrypted with identification code recognisable by the player's card reader and by the regulated establishments. The smart card is issued by one regulated gaming organisation or its agent and it can be used by all other similarly regulated organisations. The smart card reader is supplied by the regulated gaming establishment and is encrypted with an identification code which is recognised by the ABC smart card as well as all similarly licensed gaming establishments. When the player wishes to commence a game, the player authenticates himself or herself with the stored details in the card by either a PIN or by biometric means. Identification via the reader or via a card that has the ability to self-check the fingerprint touching the card with the stored digital image of the fingerprint.

Once it has been confirmed by the smart card reader that the player is the owner of the card, the player logs onto the gaming system. The Internet or other gaming establishment checks the files to ensure that the ABC smart card is authentic by way of encryption interrogation software. Further checks such as the card validity or whether it has been subject to a stop order will also be carried out.

A2 Card Issuance

The issuer issues the card including producing the correct data for the personalisation of the card and forwarding the to the card production bureau. The personalisation data would include the data forwarded from the Regulatory Body. Arranging for the card to be forwarded to the cardholder, or alternatively, maintaining the stock of cards and forcing the applicant to collect the card in person if this is required within the regulations.

Capture of personal details will be a certain minimum level of information that will need to be provided by a prospective player so that gaming may be regulated. The Regulatory Body is responsible for capturing these details and providing them to the Card Issuer.

If the Regulators Body makes changes to the regulations surrounding electronic gaming, there needs to be a mechanism whereby these changes can be enforced on the already existing card base (i.e. those players who already have cards). The Scheme Operator would implement a mechanism by which those cards that are already issued would be flagged as needing an update to the control parameters contained in the regulatory application on the card. The mechanism would wait until the next time the card came in contact with the Scheme Management infrastructure and would issue the update to the card in real time before allowing any further transactions to be conducted.

The Regulatory Body role can be performed by any organisation that is deemed by the Government as a “trusted party”. If electronic gaming is to be regulated through the use of a card, it is imperative that the individual who applies for such a card can actually prove they are who they purport to be. This Is similar to the “100 point check” conducted by the banks when opening a new bank account.

The Regulatory Body would typically be fulfilled by various State and Territory Government agencies.

A3 Input Source

The source of the money into the card can be by transfer after an Electronic Funds Transfer at Point Of Sale (EFTPOS or EFT) transaction Internet banking transaction or credit/debit card transaction or cash payment at a particular authority handling the system. A substantial benefit of such a system is that the player can remain anonymous at the casino or gambling venue and such would not have the player's personal financial details. This avoids the use of pressure or coercion of the venue into providing easy transactions or non allowable transactions. For example it will not allow the use of an unlimited monthly credit card to be abused by making a multitude of advances on the pretence that the payments are for allowable expenses such as accommodation when the regulations may limit the amount of credit allowed for gambling.

The source may also be through less conventional sources such as used legitimately by those able to undertake large transactions such as million dollar transactions. Information of the individual would want to be maintained confidential while the gambling venue would still wish to know any bets are is covered or that sufficient cash has been transferred. Instead of having an open line of communication between the gambling venue and the financial institution or source instead the electronic value is verified by being downloaded to smart card.

The typical bank serves a number of roles within the gaming scheme. Its primary functions are described below.

(i) Sourcing the value contained in the float. It is not important as to whether the value is physical, electronic or a combination of both. At some point the float, or part thereof, is either deposited with or sourced from a bank by the Casino.

(ii) Sourcing value held by the player. At some point, the Player will be in contact with the bank in order to obtain physical or electronic value in order to place bets.

In the case of electronic value, a number of these schemes have a party known as an Originator. This is usually performed on a regional basis by a nominated trusted party. The Originator issues electronic value to the equivalent of funds deposited with the Originator by the Casino. In the case where the Player is gaming on an overseas site, there may be several originators involved so that electronic value can be issued, transferred and collected in a number different currencies.

In the case where a Player is gambling with an overseas casino, there may need to be settlement between the Scheme Operator, Originator and Casino. Depending on the electronic value scheme used, there may be a need to have a party performing transaction clearance. The process involves the Clearance party collecting transactions from devices or locations, validating the authenticity of the transaction and passing these to the Settlement processor.

In the case where a player wishes to convert Australian value to another currency, the Originator for the two regions (local and remote) needs to be notified that some value has either been added or removed from the respective regions. The would require some manner of settlement between the two Originators at a regional level as all electronic value is backed by actual value that has been deposited with the Originators.

Once the Casino has deposited electronic value with a bank, the bank needs to deposit actual funds to that value in the Casino's accounts. This Is commonly known as casino Settlement. If a player has used EFTPOS or EFT or Internet to purchase electronic value and the bank issuing the electronic value is different to the player's bank, there will be some end of day inter-bank settlement conducted.

One party supplies the foreign exchange (forex) rates by which to calculate the conversion of Australian value to another country's value. This Is performed in the case where the Australian player wishes to gamble at a foreign casino's site and needs to convert Australian value to the Casino's local currency (or some mutually acceptable currency).

B Regulation of the Net Amount to be Wagered per Month

The regulating of the maximum amount to be wagered each month is held as an application which is installed onto a smart card that limits the total amount that can be deposited into the players regulated “All Bets Card” (hereinafter referred to as ABC smart card) in any given month or any other time period. The amount may be determined by means agreed to the player, the national or regional Regulatory Body or such other authority or as the player and the gaming establishment mutually agree. The limit of deposit able to be loaded into the regulated ABC smart card is the maximum a player can lose within a month. Winnings can be either left on the ABC smart card to play at any time of the players choosing or transferred from the card to the players bank account or further played with or collected by the player at the casino, gaming establishment or by any other arrangement that is mutually agreeable to both the player and the casino. Winnings do not affect the regulated maximum amount that may be deposited onto the regulated ABC smart card for gambling in any given month. The function of the smart card is achieved via programming the ABC smart card purse

The cards have inbuilt regulatory features which prevent the player transferring the cards stored value across to the gaming establishment should the cards inbuilt gaming limit has been reached already in that month. As mentioned previously, any winnings stored on the card are not included in the limit held on the cards.

B1 Clock Application

The smart card determines months days, hours and minutes data and thus controls the maximum amount which can be loaded on the e-purse during the defined period such as a calendar month. The clock application which is incorporated in all ISO 7816-1-6 smart cards is accessed by the purse application. When the clock begins a new month a signal is sent to the purse opening the limit, at the end of a month closing the purse reopening the purse limit again at the beginning of the new month. Any unused monies or unused amounts below the monthly limit may be transferred to the next month.

B2 Purse Limits

The application is installed into a smart card chip which regulates the amount that can be deposited into the player's smart card purse and spent within any given month or other fixed period of time. Any winnings can be either transferred from the card to the players bank/casino account or further played with or collected by the player from the casino or gaming establishment by any other arrangement that is mutually agreeable to both the player and the casino or gaming establishment and excluding any identified problem gamblers and underage gamblers.

The player may deposit money for gaming via the ABC card in any calendar month or other period. When the preset limit has been reached the purse is closed to any further deposits for gaming for that month. The clock will reopen the purse to further gaming deposits when a new month starts or transfer any unused cash or unspent part up to the limit into the next month.

The smart card technologies have the security of having the ability to recognise and identify the player as the cardholder. Identification of the player is the key issue in the proposed regulatory environment. In the event of magnetic stripe cards being used the PIN identifies the player. The smart card due to its security features is more reliable in the authentication of the player as the authorised cardholder. The regulation of the amount wagered per week/month can be managed where the smart card is being used and controlled by the card itself. However, in the event of a magnetic stripe card being used the form a regulation governing the amount to be wagered each month is programmed into the account. The maximum amount to be wagered or the player's net gaming losses each month can be established by a variety of methods including:

government regulation;

set by the cardholder for a period of one year or other period;

linked to the player's credit card limit established by the financial institution issuing the credit limit;

set by the gaming establishment in accordance with government guidelines or other gaming charters established in conjunction with community groups;

established by mutual agreement between the player and the gaming establishment; and

any other means of establishing a limit on gaming expenditure.

B3 Purse Lock

The card applications and e-purse can be locked by the cardholder using a personal identification number (PIN) of at least 4 digits. The player has the facility to change the PIN number from the initial PIN issued separately by the regulated gaming organisation. The use of PIN prevents unauthorised use of the card by others. The card issued to the player contains a 6 digit code which identifies:

(i) in which country the card was issued; and

(ii) in which regional area the card was issued, e.g. State, Territory, District, country or other second or third tier government area.

The purpose of the code is to enable the regulated gaming establishment to identify international transactions (which may be subject to different tax regimes and/or exchange rates). Countries wishing to ban, for example, Internet gaming, can regulate Internet service providers by banning the use of the ABC smart card system.

B4 Clock Lock

The clock or clock reader on the smart card is available to determine the time or relative time. It can also be used to selectively or regulatory lock and unlock the purse. A substantial amount of gambling troubles occurs because the player is enclosed in an artificially lighted room with no indication of the time of day or the length of time the player has been gambling. The clock lock can be programmed to lock the purse after six hours use for example. Alternatively it could be locked off during work hours or during a time defined by the courts. In this way the smart card can act as a defence for problem gamblers that can be used voluntarily to help control the user or can be used as an overriding regulatory device for problem gamblers or for gamblers in general. The clock therefore may have a plurality of locks dependent on various constraints whether voluntary or regulatory.

The legal requirements may vary from state to state or country to country as to the legal minimum age requiredf of a person to participate in a session of gambling. This could lead to a player being able to gamble in one state or country yet not another due to their age. The clock could record the player's age when issued and update this age asutomatically when the birth date has been reached. This would not necessarily be an ID system but rather part of the regulatory feature required to enable a player to enter regulated sites that also require proof of age. This will allow the one card to be issued rather than a plurality of cards and the ability to give peace of mind and trust to a state or country that those entering electronically or entering physically a casino conform to the legal requyirements of that state or country as to age.

C Control of Inputs

C1 Credit Input Limits

The method of using credit cards in relation to electronic purse is a form of funds input recorded on the smart card. Credit card accounts linked to major card issuers (Visa, AMEX, MasterCard etc) have a unique numbering system which identifies them as a credit account. The smart card or input regulator can determine the source and according to the regulations determine the amount allowed to be deposited to the card. However the card also has a memory and clock and therefore can regulate or prohibit the amount of credit deposited over a set period such as a month. This therefore becomes a true control over the use or misuse of credit for gambling.

C2 Country of Input

The same numbering system identifies the cardholder's bank and the country where the bank operates and where the account is located. These features can be used to bar downloading of credit if such is not allowed by the relevant jurisdiction. It also identifies the regulations to be followed including any tax requirements.

C3 Winnings Input Limits

A critical control factor for a player is the control of winnings. Even though some gaming establishments have regulations to pay out say 94% of ingoings the trouble is that the player continues to play until all the winnings have also been spent. The intent of the player is to stop when “the big win” occurs. However the odds of a big win are minute and therefore gamblers find it difficult to be able to discern a “good win” or to discern that they are spending all of their winnings and ensuring the session to involve a maximum loss.

The card can identify the winnings and by use of the clock or clock reader determines a maximum amount of winnings available in a set period or session to be spent. This could be set at 50% for example, with a 24 hour period delay for access to the other 50%. This setting could be voluntarily included or be a regulatory setting. However the system allows the inclusion of both.

D1 Barring Problem Gamblers

A further feature to be installed in the proposed regulation system for national and international gaming establishments, that are licensed to provide regulated gambling, is the ability to bar problem gamblers from using their licensed ABC smart card from accessing any casino or other gaming establishment that provide licensed regulated gambling. The problem gambler can be denied the ability to bet or play games should the player and licensed gaming establishments be directed or ordered by a regulatory authority or a court or social welfare agency or by a spouse or other person under a court order.

The facility would deny a player from accessing their accounts or game entry access held at any casino or other gaming establishments) thus denying the problem gambler the ability to bet or play games should they so be directed by an appropriately designated body such as a court or social welfare agency. The non-access period could be for days, weeks, months or years or in certain cases for life. The regulatory feature will be based on the recognition of a personal cardholder number). which is automatically accepted or rejected at all betting establishments that are subject to regulatory licensing. Further more the barred player will not be able to apply for a second card during their period of disqualification.

The application could also use a thumbprint reader stored on the smart card such as manufactured by Siemens or a fingerprint scanner such as marketed by Fingerscan or other similar means.

All gaming establishments that are part of the regulated industry will be notified electronically by the Regulatory Body which provides an upgraded authorisation of all cardholders who are barred and the period for which they are barred. The database is transferred in the CPU and computer files not to accept the player's card for the nominated (preset) time. Should the card be presented to a regulated gaming establishment it would not be accepted by the establishment CPU database until the expiry date when that card would be accepted again.

D2 Identification

The smart card also provides an identification function which can be used in a regulatory manner.

D3 Barring Under Age Gamblers

As players must apply for a regulated ABC Smart card, checks prescribed by the government regulator will be carried out by an authorised agent to ensure that sufficient identification is produced to identify the player and age and set the players limit. In a number of countries a Proof of Age card is already issued based on appropriate identity checks. The card can be upgraded to a smart card where the issuing authority determines that this is appropriate. A PIN number or biometric identification will be provided to allow the player to use the regulated ABC smart card in all licensed regulated casinos and Internet casinos and all other regulated gambling establishments. Under age players will not be issued with an ABC smart card which is explained in further detail in the patent.

E1 Deny Entry to Unregulated Casinos

In order for a Casino to gain a gaming licence, it is necessary for the Casino to register with and comply with the regulations and guidelines laid down by the Regulatory Body. The Government collects tax revenue from these winnings and the current situation is that the State in which the Casino is based collects the revenue. With the advent of electronic gaming, there are some issues as to the precise definition of where the electronic Casino is resident.

The regulated ABC smart card will have a control application which will deny the player access to gamble at unregulated casinos and Internet casinos using the funds they have on their card.

The Casino (whether physical or virtual) is the channel through which players may engage in gaming. The Casino's major responsibilities are:

(i) Provision of the gaming channel. This may take many forms: tables. machines or web pages.

(ii) Maintenance of the float. The float is defined as the pool of funds that are in circulation within the Casino. The Casino's responsibility for the value contained in the float begins when the player has placed a bet and end once the Casino has either deposited the value with a bank or has paid a player for a winning bet. It is essential that the float is large enough to meet the operational requirements of the Casino.

(iii) Adherence to gaming regulations and guidelines. It is the Casino's responsibility to meet the gaming regulatory requirements and to operate within the gaming industry's code of conduct.

The Scheme Operator (SO) is responsible for administering the regulatory electronic gaming scheme. This involves a number of roles, some of which are performed by the Scheme Operator and others in which the operator facilitates the performance of other roles.

Ensuring that the player does not exceed the imposed gaming limits, as part of the scheme, a player may elect to have self-imposed limits placed on their activity within the electronic gaming space. In extreme cases, these limits could be imposed by the appropriate Regulatory Body.

Acting as a regulated portal for access to registered electronic gaming sites, by making the Scheme Operator the primary portal for access to electronic gaming sites, it will be possible to make validation of a player and the associated gaming limits available at single point of control. The Scheme Operator could also host the actual gaming sites on behalf of the Casinos.

The Scheme Operator would put in place a shared infrastructure that would allow the virtual and physical Casinos to accept electronic value. This would be managed on behalf of the Casinos and end of day settlement would occur with the bank. Provision of infrastructure to allow the Casinos to issue and manage smart cards. Again, by putting a shared infrastructure in place, the Scheme Operator could reduce the costs to Casinos who wish to issue smart cards.

Outsourcing of card management can occur if the Casino does not want or is not permitted responsibility for card management. The Scheme Operator would provide the facilities to manage the Casino's card base and manage the card through every stage of the card life cycle from card ordering to card expiration. Provision of Customer Care functions would be performed by providing call centre facilities and managing these on behalf of the Casinos. The would reduce the costs to the Casino by providing 1800 numbers for players to call should they have problems with Online gaming sites or with their smart cards.

E2 Gambling Via Interactive TV or Broadband Networks

The form of home based gaming where the player can place bets via the Internet and/or broadband cable and watch the live event or game show on TV can be regulated also using the licensed ABC Smart card. An approved ABC Smart card reader is provided in the home. Moneys are transferred onto the smart card utilising different methods including e-purse, debit and/or credit transactions. The transfer of money to the gaming establishment is via the Internet or telecommunication networks or computer networks.

### SHORT DESCRIPTION OF DRAWINGS

Having generally described the nature of the present invention, particular examples are now described by way of example and illustration only. In the following description reference is to the accompanying drawings, wherein:

FIG. 1 is a schematic diagram of the system showing the chosen example.

FIG. 2 is a chart indicating the sequence of interactions between the ABC smart card and gaming establishments that are part of the proposed regulation system of the gaming industry during a typical gaming session employed in the system of the chosen example.

FIG. 3 is a diagrammatic view of various parties involved in the scheme and using the ABC smart card of FIG. 1.

FIGS. 4.1 to 4.10 show various parts of an interaction of the various parties in the system for regulating gambling in accordance with the invention.

### DESCRIPTION OF EMBODIMENT OF THE INVENTION

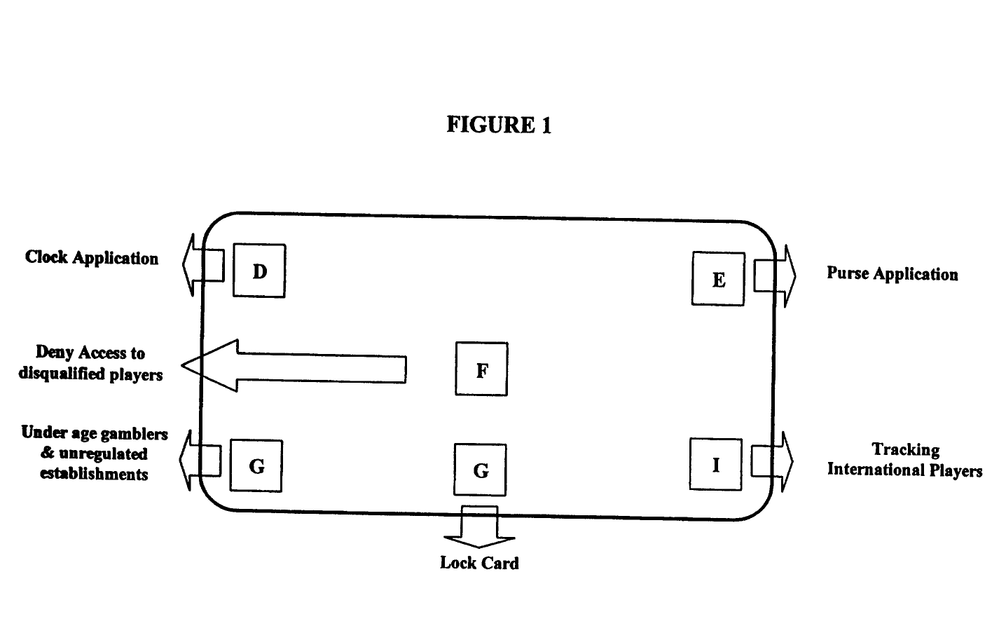

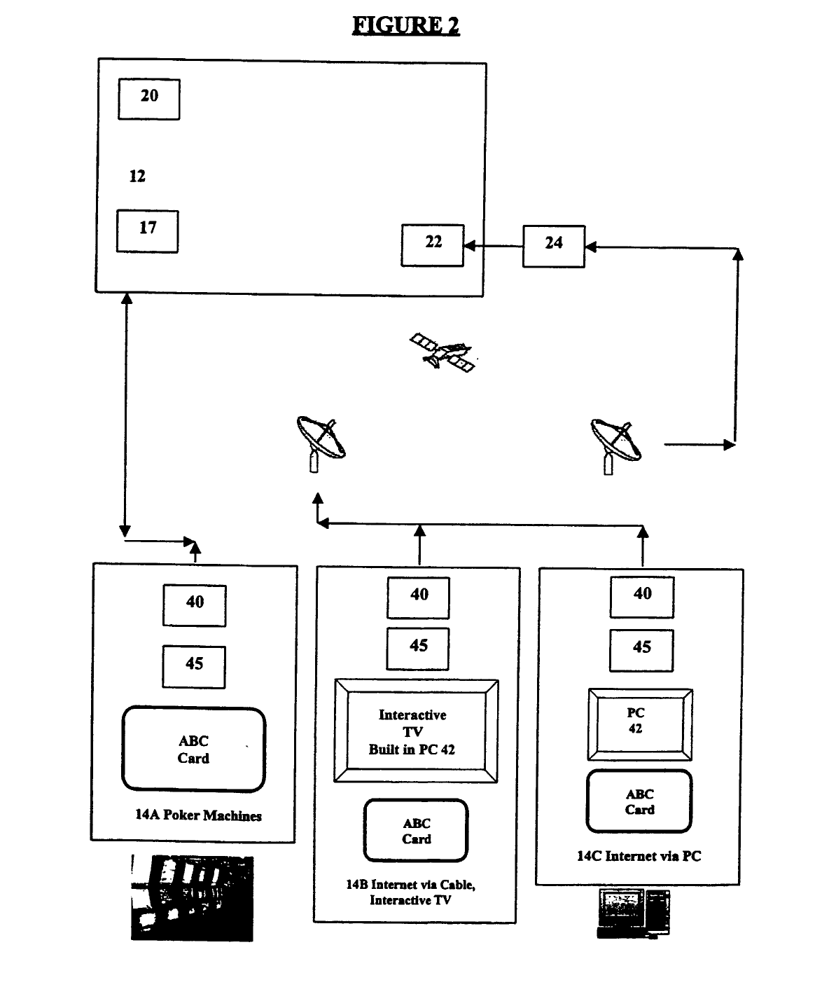

Elements D, E, F, G, H, & I in FIG. 1 show an example of a regulated ABC (all bets card) smart card system. The letter represents the applications contained in the smart card and in the smart card reader that can be programmed to regulate the gaming system. They do not indicate or relate the actual file positions of the applications stored in the chip.

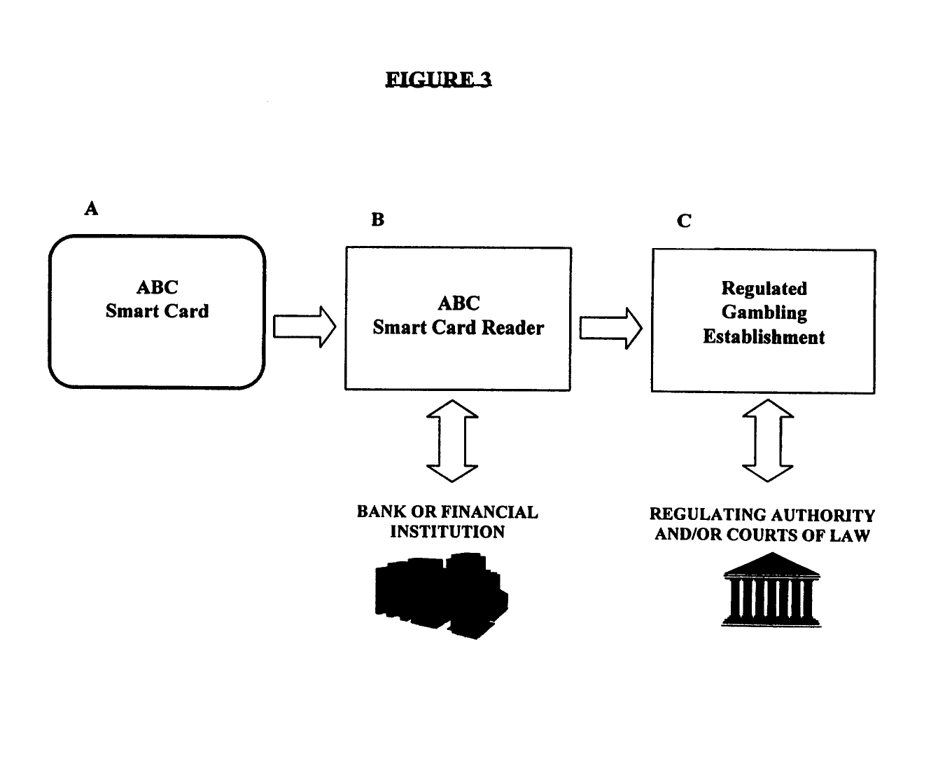

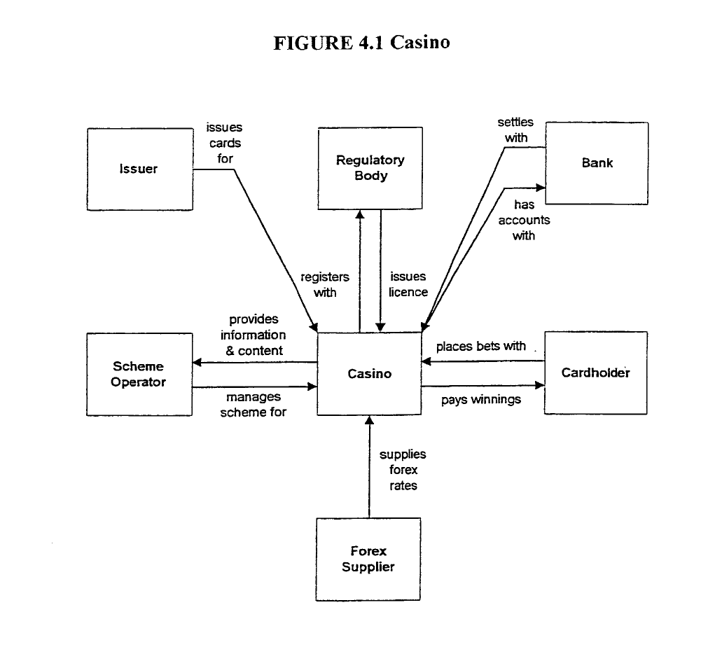

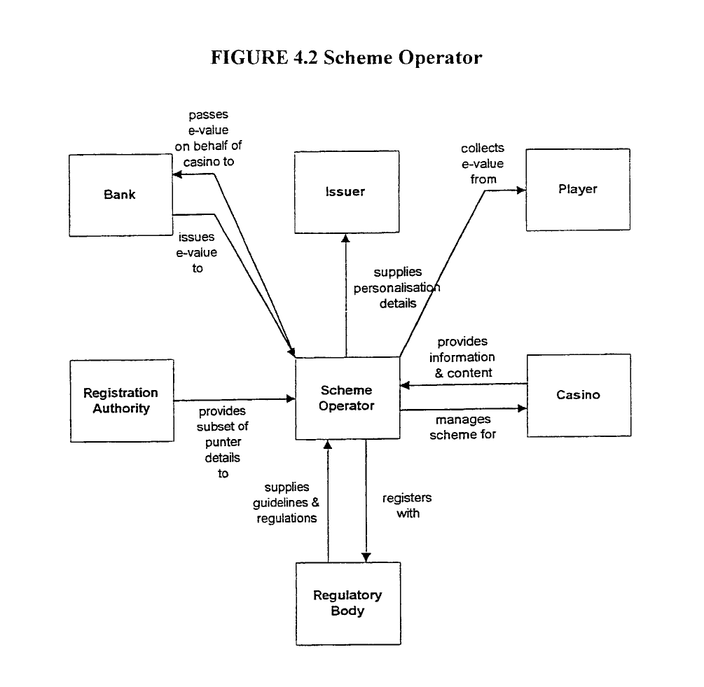

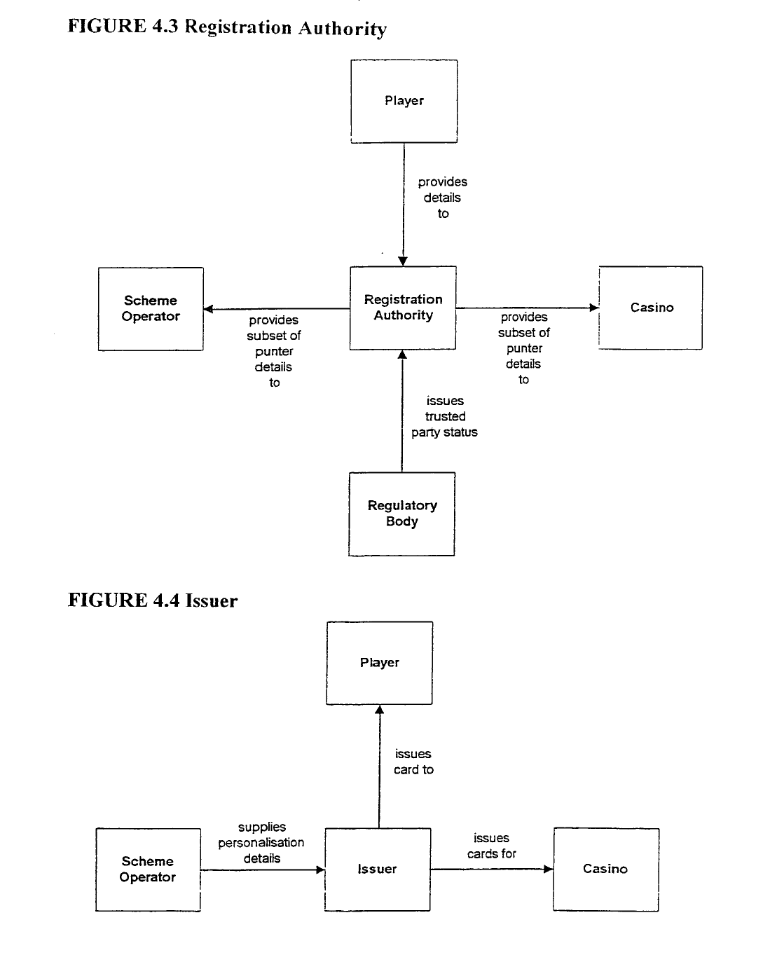

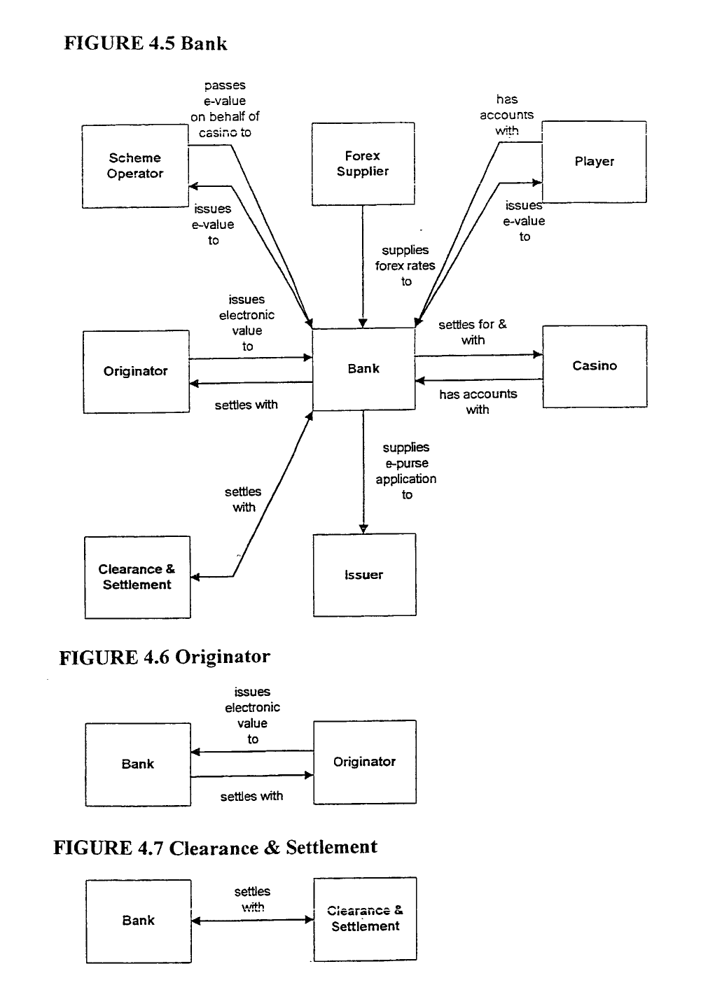

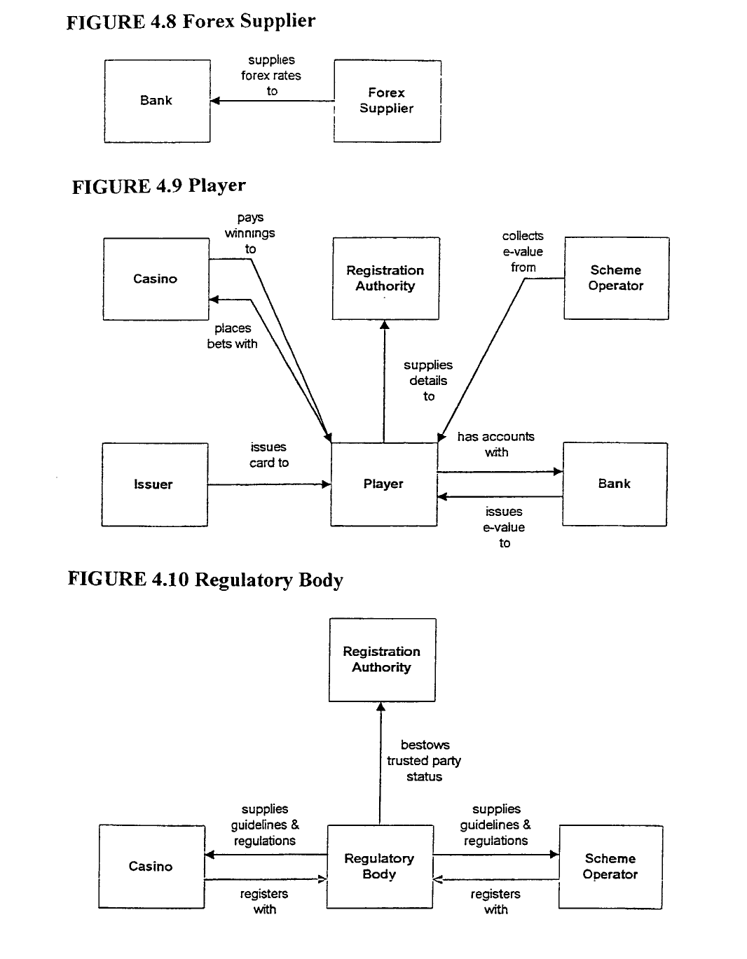

With reference to FIG. 2, the general system of the example comprises a gaming establishment 12 that is licensed as part of the proposed regulated gaming industry and three different player station examples 14a poker machine. 14b Internet in conjunction with interactive TV or pay-TV etc and 14c Internet via a PC. In the example, gaming establishment 12 houses a secure area (16) fitted with a regulated CPU (17) a PC terminal that will access the files no. 22 to store instructions pertaining to the player that may be so ordered by a court of law 20. The gaming establishment 12 also includes a regulated file server 22 and an Internet/telecommunication network such as ISDN or computer network bridge (24), server 22 being connected to PC terminals 20 and capable of feeding both data and control signals to bridge 24. Bridge 24 includes an Internet/telecommunications, computer network, ISDN and related connections. It outputs electronic data and video signals in any of the above formats to telecommunications carrier having ground transmit/receives dishes 26 and a satellite repeater 28. It should be recognised that the telecommunications link may just be a terrestrial landline or cable, or a combination of terrestrial and satellite links or landlines or telecommunication networks or computer networks. The nature of the link is immaterial to the present invention. For convenience of illustration, player station examples 14a, 14b and 14c are shown as each being connected either through an Internet/telecommunication ISDN or other type of computer network modem 32 from common dish 28 but it will be appreciated that these stations may be physically situated within a regulated gaming establishment or within a city, state or country or in different countries and connected to different telecommunication links or other different dishes. Each player station 14b and 14c of the example comprises of an interface unit 40 which includes a modem that corresponds to the telecommunication medium employed and which is connected to PC 42 or in the case of player station 14a interface unit 40 which includes modem connection with a poker machine that is fitted with an ABC smart card reader PC 42 is connected to a smart card reader/writer unit 45. Smart card unit 45 is equipped with a biometric enabled smart card reader/writer or PIN identification system (not separately illustrated) which includes a fingerprint recognition device. For example Siemens markets a smart card capable of recognising the thumbprint or fingerprint on the card which can be verified against the digitally stored record held on the smart card by the smart card reader. Alternatively a smart card has the ability to read the fingerprint that is stored in the card chip with a finger scanning such as marketed by Fingerscan.

The ABC smart card is used to establish a player's purse for each game is supplied by the regulated gaming establishment and is encrypted with identification code recognisable by the player's card reader and by the regulated establishments. The encryption system may incorporate public key Infrastructure (PKI) where this is applicable in particular countries. The smart card is issued by one regulated gaming organisation or its agent and it can be used by all other similarly regulated organisations. The smart card reader is supplied by the regulated gaming establishment or its agent and/or is encrypted with an identification code which is recognised by the ABC smart card as well as all similarly licensed gaming establishments. When the player wishes to commence a game, the player authenticates himself or herself with the stored details in the card by either a PIN or by biometric means or other means. Identification via the reader or via a card that has the ability to self-check the fingerprint touching the card with the stored digital image of the fingerprint.

Once it has been confirmed by the smart card reader that the player is the owner of the card, the player logs onto the gaming system. The Internet or other gaming establishment checks the files to ensure that the ABC smart card is authentic by way of encryption interrogation software. Further checks such as the card validity or whether it has been subject to a stop order will also be carried out. The cards have inbuilt regulatory features which prevent the player transferring the cards stored value across to the gaming establishment should the cards inbuilt gaming limit have been utilised already in that month. As mentioned previously, any winnings stored on the card are not included in the limit held on the cards. If the processes described above are completed correctly the player may transfer the money available on the card to the gaming establishment.

If the gaming establishment is not part of the regulated industry the card cannot be used for any form of the transactions described. The above example also applies to a poker machine situated in a licensed regulated premise. The above would apply in much the same way if the player is physically playing the machine.

Referring to FIG. 3 the ABC smart card is inserted into the ABC smart card reader where the identification of the card and player is completed. Loading the card via the reader may be carried out over the Internet or telecommunication lines or computer networks to banks, or other financial services that provide the transfer of monies from the players account, EFTPOS or EFT or over the counter at a regulated gaming establishment.

The following is a high level overview of the technology involved in implementing an electronic gaming regulatory system.

The card is central to the provision of a regulated gaming scheme. By implementing with a smart card, it is possible to perform validation of the player's gaming limits both at a physical machine level and in the virtual gaming space. Because the card has a chip on it, the data physically belongs to the cardholder as opposed to a specific organisation—the assists in addressing any possible privacy concerns.

Given that the majority of the Australian State Governments have endorsed the MULTOS platform, it would seem a given that any gaming smart cards would be based around MULTOS. MULTOS is a secure operating system that resides on the chip of the smart card and the CPU and computers in the system—much in the same way that Windows is an operating system for PCs. There are a significant number of card operating systems available in the marketplace today, but none have the complete set of capabilities that MULTOS possesses.

In the area of smart card security MULTOS has been accredited with an ITSEC E6 rating. ITSEC is a European based organisation which performs security checks on software and hardware platforms. An E6 rating is the highest civilian security rating that ITSEC issue. It is important to note that only specific releases of MULTOS when implemented on specific chip types have achieved the E6 rating. MULTOS cards have an in-built cryptographic processor on the chip. The provides the ability to encrypt transactions before they are sent via the public network. The also allows the data stored on the chip to be made impervious to hacking attempts. MULTOS, as with a number of other card operating systems, allows the card to carry multiple applications on the chip.

Previously, cards were limited to having just a single application placed on them. This means that in addition to the Regulatory application, the card is capable of carrying a Loyalty application, an Electronic Purse application and a Digital Certificate. This provides a value add to the Casinos, as they can encourage return gaming by providing loyalty incentives to players and through the use of the electronic purse, eliminate the overheads associated with handling large amounts of cash.

The MULTOS security features ensure that these applications cannot interact with each other (except according to some stringently specified rules) and that the data contained within each application is securely firewalled from other applications.

The Regulatory application would be the controlling application for the player. It would, conceivably contain the following information:

Cardholder details: Name, Address, Unique Gaming Number

Gaming Controls: PIN to access the application. Gaming Limit for the month (or other nominated time period). Value that has been wagered so far. Length of the gaming period. When the gaming period started. The application would be interrogated at the start of a gaming session by either the virtual Casino site or by the gaming machine itself. The gaming channel would have the information about the gaming limits to be applied to the individual player. The gaming channel would not let the player wager more than the pre-applied gaming limit.

After the player had uploaded their stake for the gambling session, the gaming channel would update the gaming control information to indicate that the player had the possibility to wager the entire stake. In a worst case scenario (for the player), this is indeed what would happen and the card would represent the true total of value that the player had wagered. If the player did not wager the entire stake, the gaming channel would need to update the gaming control information to reflect the amount that the player had wagered. This would prevent the player from removing the card from the card reader in an attempt to prevent the gaming control information from being updated.

The update to the gaming control information would be enforced by not allowing the player to reclaim their remaining value of their stake or their winnings until the control information had been successfully updated.

The card would include typical loyalty applications with the difference that the loyalty points are carried on the card. This would provide the Casino with the ability to provide instant redemption at the Casino venue or to operate predetermined rules established by State regulatory authorities. The Casino could encourage return patronage by providing access to goods and services within the venue through redemption of points. Depending on the sophistication of the loyalty application, various parameters could be applied to different individuals to vary the number of points accrued. This would allow personalisation of the loyalty scheme down to an individual level.

An essential part of an electronic gaming scheme is a secure mechanism to transfer value across the Internet. An ideal way of achieving this is through the use of an Electronic Purse. There are two major standards within the space of electronic purse schemes and these are described below. One of these schemes transfers value chip-to-chip. i.e. both parties to the transfer are required to have a card and all transactions between chips are protected from tampering by a high level of encryption. The other uses card chip to host system transfer.

Mondex value is originated on a regional level. Several banks within Australia have bought into the Mondex franchise for the Australian region and as such Mondex value is available. Mondex has a security rating E6 from ITSEC and as such is the most secure electronic purse scheme available. Mondex is an anonymous purse scheme which means that value can be transferred between parties without central audit details being recorded. In this respect, Mondex is equivalent to cash, in that cash can also be exchanged anonymously.

During the day the Casino would collect Mondex value and at end of day would transfer all or part of the value to the bank in a lump sum. Settlement of Mondex value would occur when the value has been transferred back to the bank. The bank would credit the Casino's accounts with equivalent in actual value. A Mondex purse is able to carry up to five nominated currencies which provides the ability for the gaming portal to offer the services of overseas Casinos and for local Casinos to accept value and wagers from overseas players. Another valuable feature with the Mondex purse is the ability to set purse limits for an individual cardholder, i.e. an individual purse can be set so that it can only hold a proscribed amount of value at any one time. The adds further security and control over the gaming limits that can be set for a player—especially those that fall into the category of “problem gamblers”.

Finally, there are a number of commercially available Value Management Systems for Mondex that allow the management of a large number of chips at the casino level which provides for high availability and high throughput of value transfer transactions. There is a significant expense involved in implementing these systems, so a shared infrastructure model would again provide cost savings benefits.

Visa Cash is a slightly different type of purse. Visa Cash value is issued by banks on an ad hoc basis. Rather than a central bank body such as the Reserve Bank of Australia originating and managing the amount of electronic value in circulation, banks are able to issue Visa Cash in exchange for funds. It is worthy to note that Visa International regulations prohibit using a credit card to obtain electronic Visa Cash value.

Visa Cash is what is known as a fully audited system. The only way Visa Cash value can be redeemed is by transferring value from a consumer's card to a casino. The issuance of casino devices is strictly controlled by the casino acquirer (usually a bank).

Over the course of the day, the Casino captures value to their acquiring device and at end of day (or at some other pre-designated time) the Visa clearance centre contacts the device and collects all the transactions that have been performed. These are processed in manner very similar to credit card transactions and the value is sent back to the casino (through a bank) using the existing Visa settlement network. There are currently systems for managing Visa Cash value on a large, centralised scale for casinos but the fully audited nature of the system makes it less suitable for application to gaming given the anonymous nature of the current gaming model.

To allow non-repudiation of transactions between the Player and the Casino, it is possible to place a Digital Certificate on the card. This would allow the Casino to authenticate that the person using the card is the actual cardholder. It would also allow the Gaming Portal to authenticate that the Casino web site belongs to the registered Casino.

The gaming channel would be required to perform the following steps regardless of whether the channel was an Internet site or a physical machine. If the channel were to be a machine the machine would need to be equipped with a smart card reader.

If the gaming channel is virtual the card generates a request and authenticates the Casino's digital certificate to ensure that the site belongs to a registered Casino.

Read the gaming control information.

Authenticate the certificate

Validate that the cardholder is the actual person by having them enter a PIN.

Check the amount of value that the cardholder is allowed to wager.

Check how far through the nominated gaming period the player is.

If the player has passed the end of the gaming period the gaming period start date is updated and the total amount wagered in the gaming period is reset back to zero.

Capture the Digital Certificate to allow for non-repudiation of the transactions that will be performed during the gaming session.

If all of these checks are passed the channel will permit the following steps to occur.

Upload the value from the electronic purse. The would either be a nominated amount, the amount of value that the player is allowed to wager in the gaming period or the total amount of value remaining on the electronic purse—whichever is the lesser.

Update the control information with the total amount that has been uploaded. This is added to the total amount of value that has been wagered in the gaming period.

Allow the player to conduct a gaming session by placing wagers.

At the end of the gaming session the player would indicate that they wish to exit the gaming site. The gaming channel would need to perform the following steps.

Interrogate the gaming control information.

Update the total amount that has been wagered during the gaming period.

Transfer the remainder of the cardholder's stake or the total winnings.

Update the loyalty points if there are Loyalty applications present on the card.

Supply of gaming over the Internet will require a number of services to be provided either by the Casinos themselves or by the Scheme Operator in an outsourced model. An important part of the gaming experience for the player is going to be the Online interface. With the advent of animated graphics and Java applets the interface supplied through a browser will be much more sophisticated than those supplied by traditional gaming machines. Currently, the most common operating system to provide wide spread smart card support are the Microsoft Windows operating systems (Windows 98, Windows NT and Windows 2000). This would mean that players without mainstream Windows systems may not be able to conduct Online gaming. Two browsers would have to be supported: Netscape and Internet Explorer. Due to the differences in these two browsers and their varying support for Java and XML, two versions of the interface would need to be developed and made available to players.

An essential part of the gaming infrastructure will be the establishment of a robust, high capacity IP network. It is imperative that the network have a high availability and rapid response times. Without these two attributes, players will become disillusioned with the gaming site. It is also possible to extend the IP Network supply into the provision of a gaming portal. This would provide access to all the registered gaming sites and allow generation of advertising revenue by providing companies space on the portal site. By having a single portal, more control could be placed on the players and allow collection of information about general gaming trends (as opposed to specific information on cardholders). Cost savings for the Casinos could be realised by having the IP Network supplier also conduct the Web hosting for the Casino.

The parties involved in a regulated electronic gaming scheme interact as shown in the figures. The day to day operation of a gaming scheme will involve a number of processes. The section is a discussion of these processes and the manner in which the various parties will perform them. As part of a gaming scheme establishment and operation, there is the necessity to lay down the regulations and guidelines governing the scheme. To the end it will be necessary for the Regulatory Body to hold discussions and seek input from the various community groups, other Government Agencies and the various parties who will be participating in the operation of the scheme.

Once the process has been completed, the Regulatory Body is responsible for creating the regulations and guidelines and disseminating the information to all interested parties. When a potential player wishes to obtain a card to allow them to conduct Online gaming, the Player must supply a number of details to the Regulatory Body to validate their identity. These details are held by the Regulatory Body. The Regulatory Body performs the equivalent of the banks' “100 point check”. The details that are captured are vetted against the regulations and guidelines and the limits on the player's gaming are established. A subset of the details is forwarded to the Scheme Operator (SO) so that the SO can create a personalisation file for the card bureau. The SO places an order for cards with the card bureau. The card bureau is responsible for the production of the card and printing any brand identifiers. The chip is personalised with the details supplied by the SO and the card is boxed along with a card reader, instructions and conditions of use. This is mailed to the address supplied by the Player. At a later stage, the PIN to activate the card is mailed to the cardholder—much as it currently is with debit and credit cards.

Once the Player has received the card, card reader and PIN mailer, they are ready to login to the gaming portal. The portal will provide the facility to load value onto the card after transferring funds to the appropriate bank. The Player can choose from the registered gaming sites that have their site available through the gaming portal. The Player places wagers with the Casino according to the previously mentioned process that prevents the Player from collecting their winnings without having the Regulatory Application updated with the details of their current gaming session.

As part of the process of logging into the gaming portal, some Player details will be captured. One piece of information will be the registered location of the Player (i.e. which State the cardholder resides in). In addition the registered location of the Casino will be captured and the amount of electronic value that has been wagered and won/lost. This will allow the distribution of gaming tax revenue to be conducted according to the agreement between the State Governments over such distribution of funds.

When looking at the settlement of value between the Casino. Scheme Operator and Bank there are two models available—one based on a physical gaming channel (i.e. machine) and one on a virtual gaming channel (i.e. Web).

In the virtual model, the Scheme Operator will maintain either a pool of casino chips or a host system file for the Casino as part of the back-end infrastructure. A particular pool of chips or file will be maintained for each Casino—if the Casino elects to have the SO perform the function on their behalf. Settlement would be scheduled according to the business rules defined by the Casino. This would be end of day, at predetermined times or according to the necessities of the purse class rules and a particular chip that has reached, or is approaching the value storage limits defined for that particular purse class. As part of the settlement processing, the value contained within the managed pool of chips or host system is transferred to the Bank-based Value Management System. The Bank, upon receipt of the value and notification of the Casino for which the value was held, will settle with the Casino by depositing actual funds into the accounts held by the Casino according to the business rules defined by that Casino. This could entail a process whereby the funds would be converted to a currency nominated by the Casino and an international transfer made to the Casino's offshore bank. This would only occur in the case where a Casino was resident offshore, had registered with the Regulatory Body and placed their virtual gaming channel on the gaming portal.

Machine Based (if machine is equipped with casino chip) is a more complicated model as the machine would need to be physically modified in order to be equipped with a casino chip. The machine must monitor the value contained in that chip and as the limit for the purse was approached, the machine would have to transfer the funds to the Scheme Operator's Value Management System. Settlement would occur as per the virtual model. The model is not recommended as the machine could be responsible for issuance of value if the Player was a net winner. The functionality is far more easily supported in a centralised value management model.

The implementation of a regulated gaming scheme would consist of a number of steps at a high level. These include:

(i) Establishment of Regulations & Guidelines

(ii) Identify Scheme Parties and Organisations

Each State Government would be responsible for endorsement of the Scheme Operator and Regulatory Body. The Scheme Operator would contact the various Casinos in order to obtain details of the Casino's banking requirements. The various other organisations selected would depend on the Casino and Bank's business requirements.

(iii) Establish Back-End Infrastructure

Establishing the back end infrastructure would be role of the Scheme Operator. The would involve developing a capability in the following areas:

Scheme management

Web hosting

Portal management

Value management

Security

Gateway to EFTPOS or EFT

Tax levying functionality

Network

(iv) Design/Source Card Applications

The Scheme Operator would work with selected smart card application developers and application suppliers in order to provide the suite of applications needed to implement a Regulated Gaming Scheme. There are currently a number of organisations in the marketplace that have a MULTOS application development capability.

(v) Design and Develop Browser Interfaces

Again, the Scheme Operator would work with the Casino, a Web application developer and a Graphics Consultant to design the browser interface for a particular Casino's virtual gaming channel. The SO would also be responsible for the development of the Portal interface and functionality.

(vi) Design and Develop Virtual Gaming Applications

In conjunction with the Casino, the Scheme Operator would develop the back end virtual gaming applications and with the gaming device supplier to modify the physical gaming machines in order that they would be able to accept electronic value. These back end applications would have to be stringently audited by both the Casino and the Regulatory Body to ensure that they complied with all the regulations associated with gaming machines.

(vii) Establish Gaming Portal

Establishment of the Gaming Portal would consist of registering the domain name and commissioning the card applications, back-end application and interfaces.

(viii) Establish Education Programs

An important part of Scheme Establishment will be the requirement to develop and instigate education programs to assist the Casino, the Player, Government and the various Community Groups in becoming comfortable with the new technology and the operation of a Regulated Gaming Scheme.

(ix) Establish Customer Care Capability

The customer care facility would be based around a phone based call centre model with physical customer interaction happening at Casino premises. The Casino's would be responsible for the supply and education of customer care staff within these premises. Within the Gaming Portal it would be necessary to supply access to assistance and education so that call centre staff could interact with a cardholder via the Web.

(x) Establish Registration Authority

Once the Registration Authority is established, cardholders can start registering for a Gaming Card. The Registration Authority would have to be selected by the Regulatory Body and audited to ensure that the Registration Authority met all the applicable regulations and guidelines surrounding security and privacy. Only then will the RB issue the Registration Authority with “trusted party” status. Additionally, the RB would issue guidelines and audit the interaction between the SO and the Registration Authority.

(xi) Issuance of Cards

With all the preceding pieces in place, it would be possible for card to be issued to players. Initially, only the virtual gaming channel would be available to players while the physical gaming channels are modified and rolled out.

(xii) Modification and Rollout of Machines

Given the cost of designing, developing, auditing and the physical rollout of modifications to the physical gaming channels, it is proposed that the rollout happen over a period of time. The would allow savings in costs to fund the modification and rollout of further machines. Steps involved in the modification of machines would be as follows:

Design of physical modifications to the machines so that they could accept smart cards.

Design of the software changes necessary to interact with the various applications on the card (Regulatory application, E-purse application, Loyalty application and Certificate application).

Audit of the above components by one or more trusted parties.

Implementation of the physical modifications and software modifications in a staged manner.

Commissioning of the physical gaming channels.

(xiii) Operation of Scheme

Finally, the Scheme Operator would take over day to day running of the various SO support functions. The Gaming Scheme would be deemed to be live.

Issues to be considered are:

Origination of electronic value of different currencies.

Exchange rate setting when exchanging electronic value in one currency for another.

Settlement with overseas originators—when exchanging electronic value in one currency for value in another currency it is in effect transferring value from one scheme and adding it to the total value in the other scheme.

High entry cost for implementation of infrastructure.

Resolution of the issues surrounding the collection of tax revenue from gaming needs to be agreed with appropriate taxation bodies. By this, it is meant that the origin and destination of a gaming transaction needs to be defined in the virtual model given that it is straightforward to define these roles when a Casino is physically present in a location.

Compliance with Privacy regulations—the proposed system is designed specifically in the region of access to personal details and gaming activity information and complies with current privacy legislation. The data needs to be managed in a sensitive manner and access to it needs to be tightly controlled.

Auditability—the scheme incorporates a large number of requirements which cover the conditions of auditing. These audits would apply to the financial nature of transactions, the management of information, security considerations, accreditation and maintenance of accreditation status as a “trusted party” by the Registration Authority.

In physical machines, the transaction between the player's card and the casino card can be local or remote, i.e. the machines would be equipped with a chip and the machine would route the transaction to a centralised Value Management system. The limit of the purse for winnings would be established by the casino depending on the maximum amount tat a player could win in a session. This limit would not alter the limit per month or other period set by the player or other authorised body.

Mondex purse classes. The Mondex system can maintain a record of the player's winnings and allow them to download in instalments.

The card manager, which in most schemes is the SO, is able to manage the card through its entire life cycle. Life cycle for the purpose of the document is defined by table 1. The card manager must also manage cards from different platforms (MULTOS, Visa Open Platform, et al) and will provide a facility to produce personalisation data for delivery to a card production bureau. It is important that the card manager be able to maintain multiple brands of cards (or card domains) and allow these domains to be managed separately. The card manager must allow the maintenance of a hot card list. These lists must be able to be sent to the transaction manager to prevent usage of the card once it has been reported as lost, stolen or damaged and new cards to be on an update list.

The SO will offer clients a scheme management service. A card scheme is defined as the collection of applications (or application set) placed on a smart card. Scheme management must provide a facility for recording applications loaded to a smart card, card life cycle rules, card scheme business rules, state of the card application(s), data and fabrication requirements for each defined smart card scheme. The scheme data, especially the card scheme business rules is able to be amended in real time to reflect changing operational business requirements. Scheme management must also include the ability to migrate the card base dynamically over a defined time period. Pricing information on a per card basis (including applications) will need to be held for billing purposes, plus contractual pricing related to scheme establishment and report generation.

The delivery of applications to the smart card must be able to performed automatically when a card comes into contact with a card accepting device which can make a change to the application set which has been performed or on demand after a request from the cardholder. The application manager must also manage the current version and state of the application on the card. An individual application on a single card or a range of cards must be able to be blocked. The blocking must take effect automatically the next time the card comes into contact with the back end solution. If a new version of the application is made available, the application manager must be able to manage the transition to the new version of the application across the entire card domain via the dynamic delivery component.

Interface with the card manager so that “hot card” or update card lists can be dynamically updated and support within the transaction manager to block access from these cards. Interact with application load devices and the application manager so that application load, delete, block and update functionality can be supported. Interface to a defined web gateway or server so that electronic value can be captured from Communication partner hosted or other Internet pages. Interface to a defined web gateway or server so that card applications can be managed. The system has the ability to log transactions for later reconciliation and billing processing. Online update lists of hot cards, business rules and access to transaction figures. It provides reporting capability and ability to define new report formats. Ability to define new transaction logging criteria.

The SO must be able to collect smart card payments for goods or services on behalf of casinos. Value must be able to be transferred from the casino system or smart card to either the SO card in the value vault or via the backend vault. The SO must be able to identify a commission component which is a percentage of the value of the payment accepted on behalf of the casino, for all payments processed. At a predetermined time client value held in the value vault must be able to be transferred to the partner bank via the bank smart card or via the backend host system. For the purposes of the proof of capability it will only be necessary to display the automated processing necessary to initiate a transfer of value to the partner bank.

The scheme operator will provide the ability to define accounting structures relating to casinos so that their individual proportions of the total electronic value pool can be determined at any given time. The structure would be in the representation of a pool (which is SO managed) and a second accounting structure that represents a casino's position with its bank.

Reconciliation occurs at end of day when a schedule is produced showing the allocation of real funds the bank holds for transactor (to back the electronic funds that have been transferred) to the various casinos (less of course any transactional fees. The schedule will be produced in a format acceptable to the partnering bank(s) and when produced the schedule entries will be reflected by a debit to casino accounts held within the value management system. For the purposes of the proof of capability an electronic report would satisfy the schedule requirement.

Any smart card used should be ISO 7816 Compliant and in future ISO 14443 compliant)

The card will be resistant to adverse environmental factors like heat, humidity, moisture, Electro-magnetic interference and radiation, etc.

The card will be able to withstand a high degree of bending at any angle without causing damage to the card and the chip

The card material will not be easily obtainable from any unauthorised sources and able to provide maximum security against fraud

The durability of the card will be at least 3 years

The card will be able to perform various cryptographic functions available: ie. using systems such as DES, RSA, ECC

In view of the high security and durability requirements, the proposed solution provides demonstrated achievement of External Security Evaluation Methodologies ie: DSD Rating

The card has the capability to load and unload applications independently

The card must meet Privacy and Consumer Protection Legislation and national principles for fair handling or personal information

The terminal achieves communication via ISO standard protocols ie: ISO 7816

Smart cards require software to operate, similar to a personal computer. Specifications exist for multiple types of operating software for smart cards described as “open” ie: MULTOS, Smart Cards for Windows versus “Proprietary” software ie: MPCOS, Memory Cards. To perform the capture, assessment and function of all data created by the use of the card requires logical sets of software known as Applications. These Applications exist to verify, authorise and perform operations specific to a required task.

Currently applications exist for processing many different types of tasks on smart cards. To ensure consistency and flexibility, the operating software ensures application can be adapted and changed whilst the cards are in the possession of cardholder. Selection of an “open” platform ensures the application set is flexible and adaptable to the changing requirement of each Industry. Recently, the ACT Government in conjunction with other State Governments selected MULTOS as the platform of choice for multi-application smart cards in Australia. Application sets within an “open” platform are available from existing smart card industry developers and could include such applications as:

SecureID—Used to store Identification details (Selection to be available as to the level of detail required—From Anonymous through to VIP Details)

Online Payments—Used for transactions (Distinction between gaming transactions and product/service purchase transaction must be available)

Loyalty—Used to add/subtract Loyalty points generated by using the card

Each Application utilised within the Gaming environment requires specific tasks to be performed. To give an indication of the functions likely to be performed each Application listed has been further explored below.

The main function of an Identification Application is to ensure appropriate levels of identification are enacted when the card owner wishes to transact. Some advanced form of Authorisation/Verification of the request is required. The system includes the ability to add new identification methods where appropriate ie: Digital Certificates, Biometrics. This type of application should be able to perform functions for identification on the card rather than a computer, ensuring freedom of identification at remote points as well as flexibility for the card owner to utilise the card when and where they choose. Additional layers of security are added ie: PIN where required.

Many E-Cash Applications for smart cards exist in various forms—from simple counter systems through to complex person to person transfer systems. Many electronic cash systems exist and are being used throughout the world. Broadly, electronic cash systems tend to imitate cash and therefore must display ‘cash type’ characteristics including the ability to transact anonymously.

Typical functions to be performed by the E-Cash systems include:

Loa d/Transfer /Delete value

Check Authorisation requirements—Flexibility to interact with a PIN number or Security Application(s)

Check Validity of attempted transaction (eg: Attempt to transact at a local retailer with a gaming e-cash application—return error)

Check limit(s)—Hourly Daily, Weekly, Monthly if required

The E-Cash system used in gaming would ensure the card owner agrees, commits and spends funds in a secure manner without the ability to repudiate the transactions after the event. E-Cash systems also ensure harm is minimised where gaming is not well controlled by the card owner. Access to limit information, selection of available finds and secure identification methods positions Smart Cards as a practical way of ensuring responsible gaming.

Many Loyalty programs are based on the “Spend and Earn” principle. For the purpose of this document, Loyalty program transactions are based on points. Therefore any proposed Loyalty program associated with Gaming would require a base set of functions to:

Earn points

Transfer points

Redeem points

Allocate Bonus points

Delete points (expiry)

The requirement for multiple loyalty systems enables different casinos to operate separate loyalty schemes which utilise the player's same smart card.

1. A smart card for use in controlling money flow such as in gaming said smart card including:
a clock or clock reader able to determine the actual time or time relative to previous transactions;
a purse for electronically receiving value;
an input limiting means providing at least one predetermined limit of electronically received value into said purse in one predetermined period of time with reference to the clock or clock reader; and
an output means able to output selectively at least part of the electronically held value in the purse.

2. A smart card in accordance with claim 1 wherein the input limiting means includes a plurality of predetermined limits of electronically received value including a first maximum limit, which can be a statutory maximum limit, and a second maximum limit, which can be a voluntary maximum limit able to be selected by the user and encoded into the smart card.

3. A smart card in accordance with claim 1 wherein the input limiting means provides further limits of certain types of electronically received value as the card receives the electronic value including a limit on credit, a limit on cash and a limit on winnings.

4. A smart card in accordance with claim 1 further including an output limiting means enabling selective limiting of an individual output transaction reflecting a maximum single output.

5. A smart card in accordance with claim 4 wherein the output limiting means further includes allocating predetermined outputs dependant on the selective output from the output means such as for reasons of tax, licence fees or the like.

6. A smart card in accordance with claim 5 wherein the output limiting means may be interrogated at the time of transactions in order to instigate a removal of the defined outputs to the allocated areas.

7. A smart card in accordance with claim 1 wherein the smart card further includes an identification means for including details of the user and identification confirming means for receiving input to confirm that the user is the identified user.

8. A smart card in accordance with claim 7 wherein the confirming means includes the use of a personal identification number (PIN) or biometric identification system or response to answer or the like.

9. A smart card in accordance with claim 1 wherein the output means of the smart card further outputs information as well as electronic value such that the information of transactions may be sent to the Tax Department or operating body or the like.

10. A smart card in accordance with claim 1 wherein the smart card is able to be selectively locked to prevent transactions into or out of the purse until unlocked wherein the locking means can be by means of a personal identification number (PIN), biometric means or other electronic locking means.

11. A smart card in accordance with claim 1 wherein the smart card is able to be selectively or regulatory activated clock locking means to have the clock upon identifying predetermined set times or length of continues operation of transactions lock the purse to prevent transactions into or out of the purse for a predetermined set period until unlocked by the clock at the end of that period wherein the selective or regulatory activation of the clock locking means can be by means of a personal identification number (PIN), biometric means or other electronic locking means.

12. A smart card in accordance with claim 1 wherein the smart card includes a visible clock.

13. A smart card in accordance with claim 1 wherein the smart card includes a record of the age of the cardholder and provides said age when transactions occur to ensure allowable access to gaming venues whether physically or by remote online access, and wherein the clock or clock reader periodically updates the age of the cardholder.

14. A system for regulating gambling including:
(a) identifying a person;
(b) issuing a person with a smart card having clock means or clock reader means with the capability of determining a time period and having a purse associated with the clock or clock reader being able to limit an electronic value input and/or output from the purse on the smart card for a predefined period;
(c) setting a maximum input and/or output limit for a predefined period;
(d) providing one or more gaming venues having card readers able to interact with the smart cards; and
(e) providing linkage to financial sources for electronically transferring verifiable funds to the smart card which are able to be selectively transferred to a gaming venue when the user wishes to undertake a gambling activity;
whereby the person can use the smart card to undertake gambling at regulated gambling establishments and have the total amount of accessible funds limited throughout all the regulated gambling establishments for a set period

15. A system for regulating gambling according to claim 14 wherein the set period is of the order of a month and the smart card can be used at a plurality of regulated gambling establishments and over a plurality of occasions but with a single input and/or output limit for the month.

16. A system for regulating gambling according to claim 14 including providing:
(f) a remote link to the gaming venue wherein the smart card is able to interact with a remote link to the card reader facilities of the gaming venues to allow verifiable funds transfer to a gaming venue when the user wishes to undertake a gambling activity.

17. A system for regulating gambling according to claim 16 including providing:
(g) a real time visual link with the gambling venue and a real time interaction means for providing real time instructions with regard the gambling activity to enable live remote gambling.

18. A system for regulating gambling according to claim 17 including providing:
(h) an interaction means for a gaming venue operator separate to or integral with the gaming venues' card readers able to interact with the smart cards wherein the gaming venue operator can operate a live gambling activity and enter details electronically to the interaction means to allow live remote gambling.

19. A system for regulating gambling according to claim 18 including said interaction means enabling interaction with smart cards of the gaming venue operator in order to identify authorisation of use and allow electronic transactions of funds to and from the smart card to and from the gambling person's smart card.

20. A system for regulating gambling according to claim 19 including providing:
(i) an identifying means for individually initiating use of each of the smart cards, said identifying means using biometric identification or PIN access or password or the like so as to allow only authorised use of each smart card by the person to whom the card was issued.

21. A system for regulating gambling according to claim 14 including providing:
(j) an identifying means that identifies the user of the card and interacts with the gaming venue by identifying the validity of the use of the smart card by cardholder without providing information of the cardholder such that gambling can occur anonymously with respect to the gaming venue whether transactions occur in person or by remote online access.

22. A system for regulating gambling according to claim 14 including providing:
(k) review of identified person with a check list and barring continued transactions with the gaming venue if the check list has identified the person as being banned by the courts or other regulatory body or by self inclusion on the check list.

23. A system for regulating gambling according to claim 14 including providing:
(l) output means for outputting data of individual transactions or transaction flow to one or more authorities or authorised bodies for regulatory purposes such as collection of tax or auditing purposes or other allowable purpose.

24. A system for regulating gambling according to claim 14 including providing:
(m) output means for outputting data of transactions to one or more authorities or authorised bodies on player's winnings and losses upon authorised access to linked network by means of PIN or other electronic security access.

25. A system for regulating gambling according to claim 14 including providing:
(n) input limiting means includes a plurality of predetermined limits of electronically received value including a first maximum limit, which can be a statutory maximum limit, and a second maximum limit, which can be a voluntary maximum limit able to be selected by the user and encoded into the smart card.

26. A system for regulating gambling according to claim 25 including providing:
(o) further limits of certain types of electronically received value as the card receives the electronic value including a limit on credit, a limit on cash and a limit on winnings.

27. A system for regulating gambling substantially as hereinbefore described with reference to the drawings.

28. A smart card for use in controlling money flow such as in gaming substantially as hereinbefore described with reference to the drawings.
